(19) United States
(12) Patent Application Publication
(10) Pub. No.: US 2014/0095061 A1
(43) Pub. Date: Apr. 3, 2014

(54) SAFETY DISTANCE MONITORING OF ADJACENT VEHICLES

(71) Applicant: Richard Franklin HYDE, Guttenberg, IA (US)

(72) Inventor: Richard Franklin HYDE, Guttenberg, IA (US)

(21) Appl. No.: 13/633,892

(22) Filed: Oct. 3, 2012

(51) Int. Cl. G06F 17/00

(52) U.S. Cl. 701/300

(57) ABSTRACT

A method and a system related to monitoring a safety distance of adjacent vehicles is disclosed. According to one embodiment, a method of a first vehicle includes determining that a second vehicle is in motion in front of the first vehicle when the first vehicle is in motion and calculating a distance between the second vehicle and the first vehicle through a range measurement device of the first vehicle when the first vehicle and the second vehicle are in motion. The method also includes generating an alert at an administrative server when the distance between the second vehicle and the first vehicle is less than a safety distance. The method may include applying a value data (e.g. a weight, length, and/or speed of the first vehicle) at the administrative server to determine when the distance between the second vehicle and the first vehicle is less than the safety distance.

### FIELD OF TECHNOLOGY

This disclosure relates generally to a vehicle following distance technology, and more particularly, to a method, system, and/or apparatus of safety distance monitoring of adjacent vehicles.

### BACKGROUND

Failure to maintain a safe following distance (e.g., a safety distance) separating a vehicle directly ahead may result in potentially fatal accidents. Governments (e.g. a state government) may have laws which require drivers to manage the space in front of their vehicle to ensure that there is sufficient time for the driver to react (e.g. to stop or to slow down). Drivers may be taught to maintain a distance according to a number of seconds. For example, a 30-foot vehicle may require a 4-second distance in front and a 50-foot vehicle may require a 6-second distance in front based on the government regulating automobiles.

It may be difficult for drivers to continuously gauge a physical distance ahead while also paying attention to surrounding cars and/or potentially dangerous road conditions. Moreover, drivers that have been continuously driving for an extended period of time can be fatigued. As a result, certain dangerous driving practices, such as tailgating, may go undetected and/or uncorrected.

Another consequence of such dangerous driving practices may be accidents. Vehicular collisions due to tailgating may result in injuries and/or may be fatal. In addition, drivers involved in accidents may incur costs associated therewith (e.g. traffic citation, insurance, repair, and medical costs).

### SUMMARY

Disclosed are a method, an apparatus and/or system of safety distance monitoring of adjacent vehicles.

In one aspect, a method of a first vehicle includes determining that a second vehicle is in motion in front of the first vehicle when the first vehicle is in motion, calculating a distance between the second vehicle and the first vehicle when the first vehicle and the second vehicle are in motion through a range measurement device of the first vehicle, and generating an alert at an administrative server when the distance between the second vehicle and the first vehicle is less than a safety distance. The method may further include applying a value data at the administrative server to determine when the distance between the second vehicle and the first vehicle is less than the safety distance. The value data may comprise of a type of the first vehicle, a weight of the first vehicle, a speed of the first vehicle, a size of the first vehicle, and/or a length of the first vehicle. The safety distance may be determined based on the value data.

The method may also involve calculating the distance through an algorithm that measures a physical separation between a posterior area of the second vehicle and an anterior area of the first vehicle. The method may further involve determining that the second vehicle and the first vehicle are traveling in substantially a same direction. The method may also include calculating an amount of time that the distance between the second vehicle and the first vehicle is less than the safety distance. In addition, the method may determine whether the amount of time is longer than an acceptable time value and communicate the distance and the amount of time to the administrative server communicatively coupled with the first vehicle.

In another aspect, a method of a first vehicle includes calculating a distance between a second vehicle and the first vehicle when the first vehicle and the second vehicle are in motion through a range measurement device of the first vehicle, applying a value data to determine when the distance between the second vehicle and the first vehicle is less than a safety distance, and calculating an amount of time that the distance between the second vehicle and the first vehicle is less than the safety distance. The method further includes determining whether the amount of time is longer than an acceptable time value, generating an alert when the distance between the second vehicle and the first vehicle is less than the safety distance and when said distance is maintained for longer than the acceptable time value, and communicating the alert to an administrative server.

In yet another aspect, a system includes a Global Positioning System unit, a range measurement device, and a data processor. The Global Positioning System unit communicates with a space based navigation system to determine a present location of the first vehicle and a speed of the first vehicle. The range measurement device detects a distance between the first vehicle and a second vehicle in front of the first vehicle. The data processor processes information generated by the Global Positioning System unit and the range measurement unit and executes an instruction generated through a communication between an administrative server and the first vehicle.

The system may also comprise a configuration module, a time tracking module, an analytic module, an alert origination module, and a communications module. The configuration module may compute a safety distance based on a value data of the first vehicle as determined through the administrative server. The time tracking module may calculate an amount of time that the distance between the second vehicle and the first vehicle is less than a safety distance. The analytic module may determine when the distance is less than a safety distance and when said distance is maintained for an amount of time that is greater than an acceptable time value. The alert origination module may generate an alert communication when the distance is less than a safety distance and when said distance is maintained for an amount of time that is greater than an acceptable time value. The communications module may send an alert communication to the administrative server through a network.

The methods, system, and/or apparatuses disclosed herein may be implemented in any means for achieving various aspects, and may be executed in a form of machine readable medium embodying a set of instruction that, when executed by a machine, causes the machine to perform any of the operation disclosed herein. Other features will be apparent from the accompanying drawing and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a schematic view of a first vehicle configured to communicate a distance to an administrative server through a network, according to one embodiment.

FIG. 2 is a view of the administrative server, where a value data is applied to determine a safety distance and to determine when the distance is less than the safety distance, according to one embodiment.

FIG. 3 is an aerial view of a first vehicle and a second vehicle, illustrating that both vehicles are traveling in the same direction and that the distance is calculated through an algorithm, according to one embodiment.

FIG. 4 is a schematic view illustrating a first vehicle maintaining a distance less than a safety distance for an amount of time that is greater than an acceptable time value, according to one embodiment.

FIG. 5 is a schematic view of a data processor of the first vehicle, through which an alert is generated and communicated to the administrative server, according to one embodiment.

FIG. 6 is schematic view of a system of the first vehicle, comprising of a data processor, range measurement device, and Global Positioning System unit, according to one embodiment.

FIG. 7 illustrates a set of modules of the data processor of the first vehicle, according to one embodiment.

FIG. 8 depicts a set of module of the administrative server, according to one embodiment.

FIG. 9 is a process flow diagram of determining whether the distance between the first vehicle and the second vehicle is less than a safety distance, according to one embodiment.

FIG. 10 is a process flow diagram, continued from FIG. 9, of generating an alert when the distance is less than a safety distance and when said distance is maintained for an amount of time that is greater than an acceptable time value, according to one embodiment.

FIG. 11 is a table view of the administrative server, according to one embodiment.

Other features of the present embodiments will be apparent from the accompanying drawings and from the detailed description that follows.

### DETAILED DESCRIPTION

Example embodiments, as described below, may be used to provide a method and/or a system for monitoring a safety distance between adjacent vehicles and generating an alert when a distance between a first vehicle and a second vehicle is less than a safety distance and when said distance is maintained for an amount of time that is greater than an acceptable time value, according to one or more embodiments. Although the present embodiments have been described with reference to specific example embodiments, it will be evident that various modifications may be made to these embodiments without departing from the broader spirit and scope of the various embodiments.

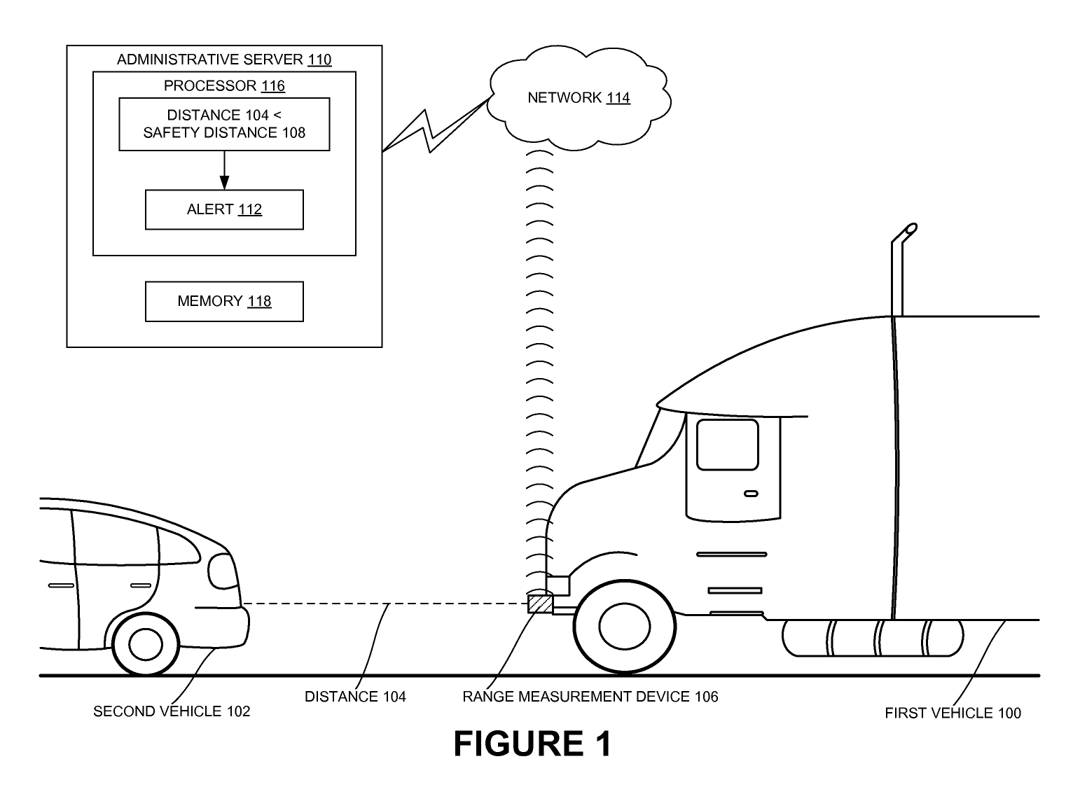

According to one embodiment, a method of a first vehicle 100 includes calculating a distance 104 between a second vehicle 102 and the first vehicle 100 when the first vehicle 100 and the second vehicle 102 are in motion through a range measurement device 106 of the first vehicle 100. FIG. 1 is a schematic view of a first vehicle 100 configured to communicate a distance 104 to an administrative server 110 through a network 114, according to one embodiment. FIG. 1 illustrates the first vehicle 100 communicating a distance 104 calculated by a range measurement device 106 to the administrative server 110. The first vehicle 100 may be an automobile, a motorcycle, a bicycle, a truck, a train, a bus, and/or any other type of ground transportation movable carrier. A second vehicle 102 may be a vehicle in front of the first vehicle 100 and may be an automobile, a motorcycle, a bicycle, a truck, a train, a bus, and/or any other type of ground transportation movable carrier.

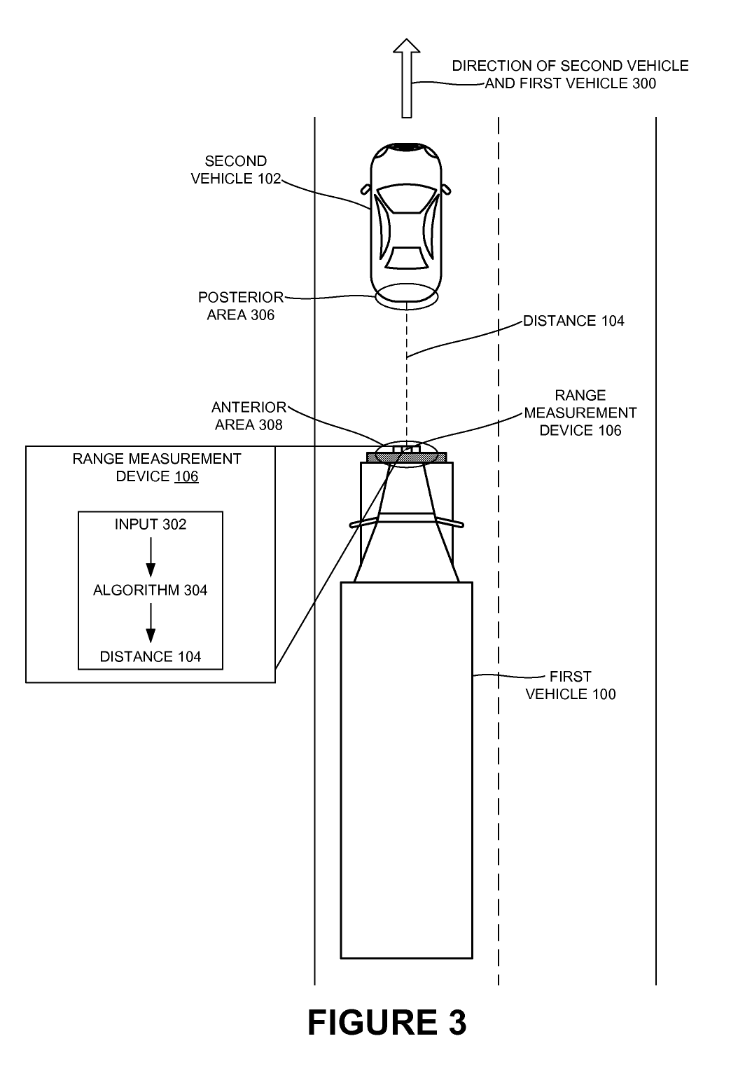

The range measurement device 106 may be an instrument that utilizes laser technology and/or an algorithm to determine the distance to a target object at which the instrument is directed. In one embodiment, the target object is the rear bumper of the second vehicle 102. The range measurement device 106 of the first vehicle 100 may be fitted on an anterior area 308 of the first vehicle 100 such that the device may accurately calculate the distance 104 between the anterior area 308 of the first vehicle 100 and a posterior area 306 of the second vehicle 102, as shown in FIG. 1 and FIG. 3. For example, the device may be secured on a front bumper of the first vehicle 100 such that the distance 104 may be calculated from the front bumper of the first vehicle 100 to the rear bumper of the second vehicle 102.

Referring to FIG. 3, depicted is an aerial view of a first vehicle 100 and a second vehicle 102 both traveling in substantially a same direction, according to one embodiment. A distance 104 is determined when a direction of the first vehicle 100 and a direction of the second vehicle 102 are substantially identical. This direction is illustrated as a direction of second vehicle and first vehicle 300. The direction of second vehicle and first vehicle 300 may be determined by a range measurement device 106. When the direction of second vehicle and first vehicle 300 has been determined, the range measurement device 106 of the first vehicle 100 may calculate a distance 104 between a posterior area 306 of the second vehicle 102 and an anterior area 308 of the first vehicle 100.

In one embodiment, the range measurement device 106 calculates a distance 104 by applying an algorithm 304 to an input 302. The input 302 may be a laser light reflected back to the range measurement device 106 and/or a number of minutes and/or seconds that is required for the laser light to be reflected back to the range measurement device 106.

The distance 104 may be communicated to an administrative server 110 through a network 114. The administrative server 110 may be a data processing system that includes a set of software and hardware components that aid the administrative server 110 in the coordination, management, and execution of various methods described herein. The administrative server 110 may be operated by an organization (e.g. a fleet company, government, insurance company, car company, etc.), an agent of an organization, or an individual that may wish to obtain the information received by the administrative server 110 and carry out tasks based on that information. The network 114 may be a mobile network and/or a Wide Area Network (WAN) that may enable communication through a wired and/or wireless network.

Furthermore, the administrative server 110 may include a processor 116 and a memory 118. The processor 116 may be an application specific integrated circuit, a state machine, a microprocessor, a field programmable gate array, etc. The memory 118 may be a random access memory and/or a primary memory of a computer system, which may store data that the administrative server 110 may utilize to execute various commands. For example, the memory 118 may store data communicated by the range measurement device 106. Particularly, the memory 118 may store the distance 104 and the value data 200 that may enable the processor 116 to determine a safety distance 108 of the first vehicle 100 and to determine whether the distance 104 is less than the safety distance 108.

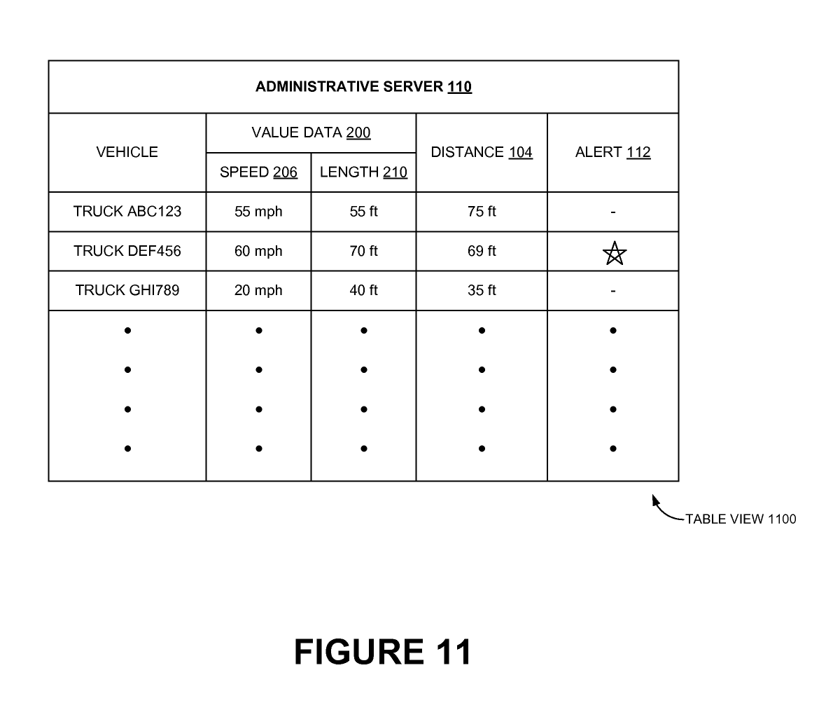

The processor 116 may also be configured to generate an alert 112 when the distance 104 is less than the safety distance 108. The alert 112 may be viewed by an administrator and/or personnel who may have access to the information stored on and/or processed by the administrative server 110. The alert 112 may be an audio or written communication that is presented to the administrator and/or authorized personnel, as shown in FIG. 11.

In particular, FIG. 11 is a table view 1100 of the administrative server 110, according to one embodiment. The table may be presented to an administrator and/or personnel who may have access to the information stored on and/or processed by the administrative server 110. In one example, the table may list the value data 200 of the first vehicle 100, such as the speed 206 and/or length 210 of the first vehicle 100. The table may also list identification information of the first vehicle 100. The identification information may be a license plate number of the vehicle, VIN (Vehicle Identification Number), and/or an identification number assigned to the vehicle by the administrator. In addition, the table may indicate the distance 104 between the first vehicle 100 and a second vehicle 102. Furthermore, if applicable to the vehicle, the table may indicate an alert 112.

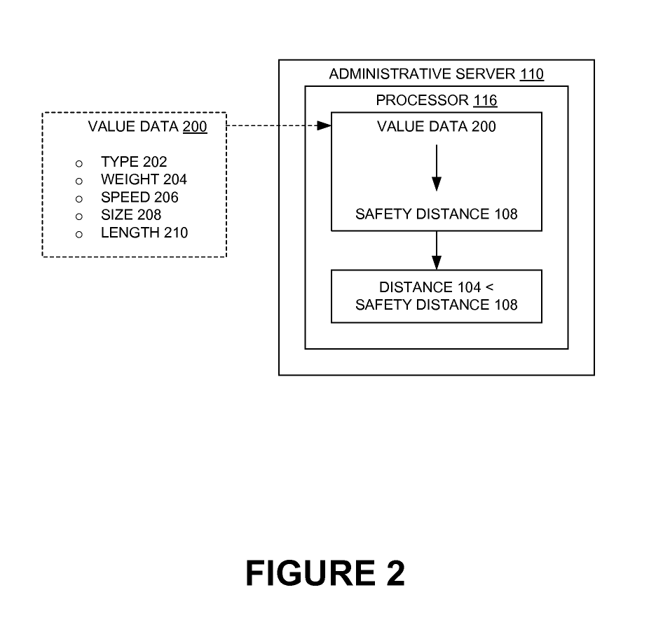

Referring now to FIG. 1, the safety distance 108 may be calculated as the distance required for a vehicle to come to a complete stop. As such, the safety distance 108 may vary from vehicle to vehicle, depending on certain characteristics of the vehicle. The safety distance 108 may vary according to a value data 200 of the first vehicle 100, as shown in FIG. 2. The value data 200 may include a type 202 of the first vehicle 100, a weight 204 of the first vehicle 100, a speed 206 of the first vehicle 100, a size 208 of the first vehicle 100, and/or a length 210 of the first vehicle 100. For example, a vehicle weighing four tons, traveling at a speed of 60 miles per hour, may require a safety distance of 200 feet, whereas a vehicle weighing two tons, traveling at a speed of 50 miles per hour, may require a safety distance of 125 feet.

Referring to FIG. 2, the value data 200 may be applied at the administrative server 110 to determine the safety distance 108 that is appropriate for the first vehicle 100. The safety distance 108 may be calculated according to an algorithm 304, as shown in FIG. 3, which utilizes the value data 200 of the first vehicle 100 and/or instructions outlined by the administrator to compute a suitable safety distance.

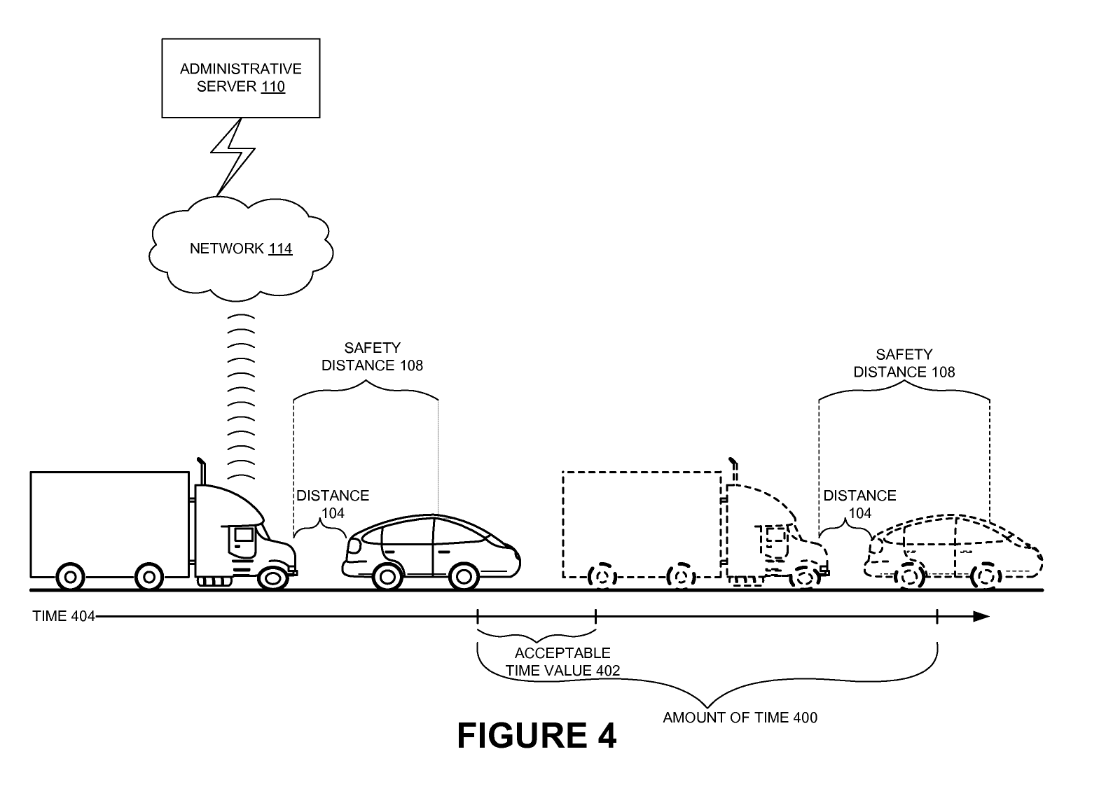

At the administrative server 110, the safety distance 108 may be compared to the distance 104 to determine if the distance 104 is less than the safety distance 108. In addition, an amount of time 400 may be calculated, such that the amount of time 400 is a period of time that the distance 104 between the second vehicle 102 and the first vehicle 100 is less than the safety distance 108. The amount of time 400 may be communicated to the administrative server 110, where the amount of time 400 may be compared to an acceptable time value 402 to determine whether the amount of time 400 is greater than an acceptable time value 402. FIG. 4 serves as a schematic view illustrating a first vehicle 100 maintaining a distance 104 that is less than a safety distance 108 for an amount of time 400 that is greater than an acceptable time value 402, according to one embodiment.

The acceptable time value 402 may be a specific period of time selected by the administrator. The acceptable time value 402 may be created and/or modified by the administrator such that the acceptable time value 402 abides by a set of rules and/or a restriction implemented by a government authority. The acceptable time value 402 may be stored on the administrative server 110. When the amount of time 400 that the distance 104 is less than the safety distance 108 is determined to be greater than the acceptable time value 402, the generation of an alert 112 may be triggered at the administrative server 110.

For example, an administrator may have selected an acceptable time value 402 to be two minutes, based on a set of rules created by a government authority. A first vehicle 100 traveling at 60 miles per hour in the same direction as a second vehicle 102 may maintain a distance 104 of thirty feet for three minutes, where the safety distance 108 has been determined to be 65 feet. Since the distance 104 is less than the safety distance 108 and since three minutes is greater than the acceptable time value 402 of two minutes, this may trigger an alert 112 to be generated at an administrative server 110.

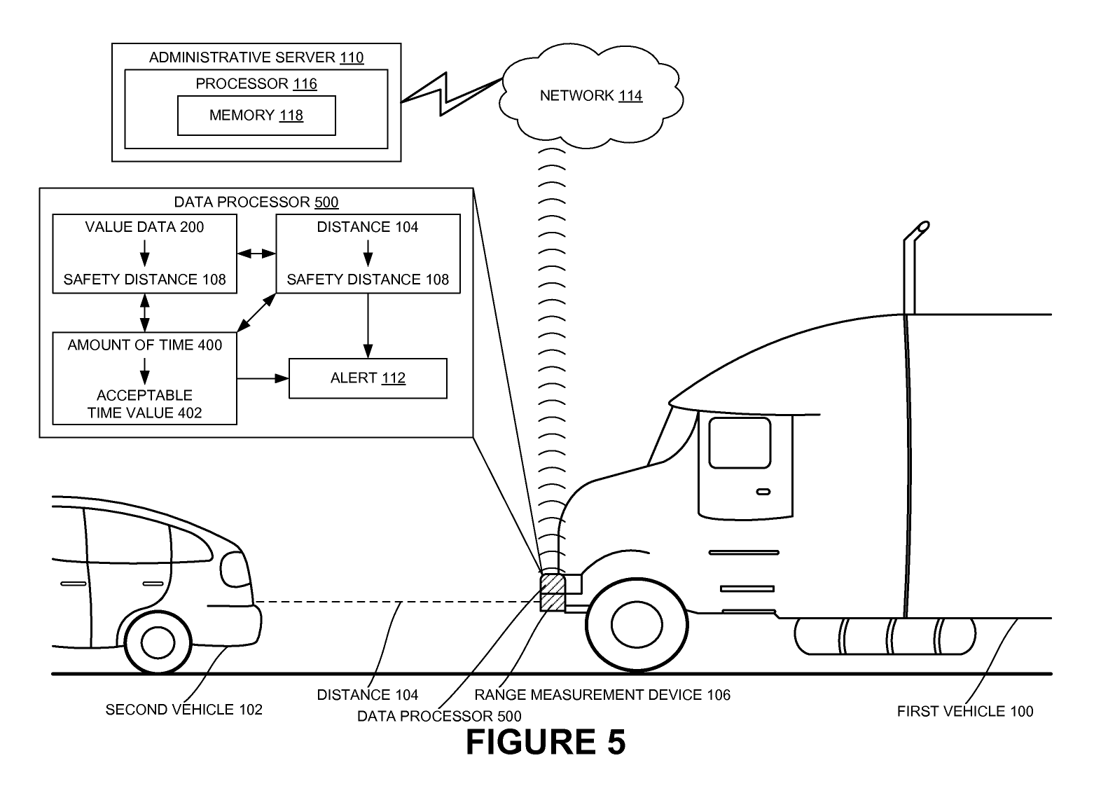

FIG. 5 is a schematic view of a data processor 500 of the first vehicle 100, through which an alert 112 is generated and communicated to the administrative server 110, according to one embodiment. The data processor 500 of the first vehicle may be an application specific integrated circuit, a state machine, a microprocessor, a field programmable gate array, etc. The data processor 500 may apply a value data 200 to a distance 104 calculated by the range measurement device 106 to determine a safety distance 108. The data processor 500 may compare the distance 104 to the safety distance 108. The data processor 500 may obtain information regarding the distance 104 from the range measurement device 106. To do so, there may be a communicative coupling between the data processor 500 and the range measurement device 106. For example, the range measurement device 106 may wirelessly communicate the distance 104 to the data processor 500.

In one embodiment, the data processor 500 may also determine if an amount of time 400 is greater than an acceptable time value 402, wherein the amount of time 400 is a period of time that a first vehicle 100 maintains a distance 104 that is less than the safety distance 108. In addition, the data processor 500 may generate an alert 112 when the distance 104 is less than a safety distance 108 and when the distance 104 is maintained for an amount of time 400 that is greater than an acceptable time value 402. Accordingly, the data processor 500 may communicate the alert 112 to an administrative server 110.

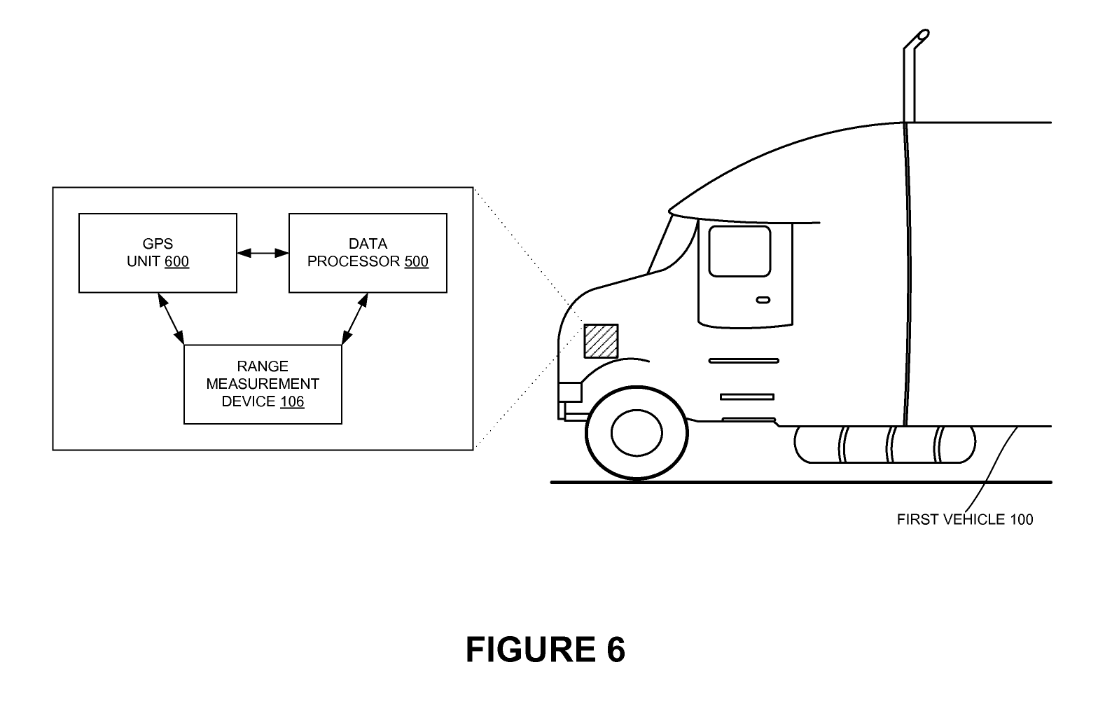

According to one embodiment, a system may include the data processor 500. In addition, the system may comprise a Global Positioning System (GPS) unit 600 and a range measurement device 106. FIG. 6 depicts this through a schematic view of a system of the first vehicle, comprising of a data processor 500, range measurement device 106, and Global Positioning System unit 600, according to one embodiment. The data processor 500, range measurement device 106, and GPS unit 600 may be communicatively coupled to one another such as to allow the transfer of data. For example, the GPS unit 600 may be communicatively coupled to the data processor 500 such that the GPS unit 600 may communicate a location and/or speed 206 of the first vehicle 100 to the data processor 500.

In this embodiment, the speed 206 of the first vehicle is determined by the GPS unit 600 through a space-based satellite navigation system that provides such information in all weather conditions, anywhere on or near the Earth, where there is an unobstructed line of sight to at least a minimum number of GPS satellites (e.g., four satellites).

In other words, the GPS unit 600 may serve as a GPS transceiver, which determines a present location and/or speed 206 of the first vehicle 100 through the space-based satellite navigation system, and communicates that information of the first vehicle 100 externally to the administrative server 110 and/or internally to the data processor 500. The GPS unit 600 may compute an aerial distance to each satellite at a speed of light. These aerial distances along with the satellites' locations may be used by the GPS unit 600 with the possible aid of trilateration, depending on which algorithm is used, to compute a position and/or speed 206 of the first vehicle 100.

In one embodiment, four or more satellites may be visible to obtain accurate information relating to the location and/or speed 206 of the first vehicle 100. In another embodiment, the GPS unit 600 may determine that information of the first vehicle 100 with only three satellites. Alternatively, when a cellular triangulation method is used by the GPS unit 600 to determine the location and/or speed 206 of the first vehicle 100, a multi-lateration of radio signals technique may be used which emit a roaming signal to communicate with a next nearby antenna tower (e.g. may not require an active call).

In one embodiment, the data processor 500 may receive information regarding the speed 206 of the first vehicle 100 from the GPS unit 600. In addition, the data processor 500 may receive information pertaining to the distance 104 between the first vehicle 100 and the second vehicle 102 from the range measurement device 106. Furthermore, the administrative server 110 may provide the data processor 500 with information relating to the weight 204, size 208, length 210, and/or type 202 of the first vehicle 100.

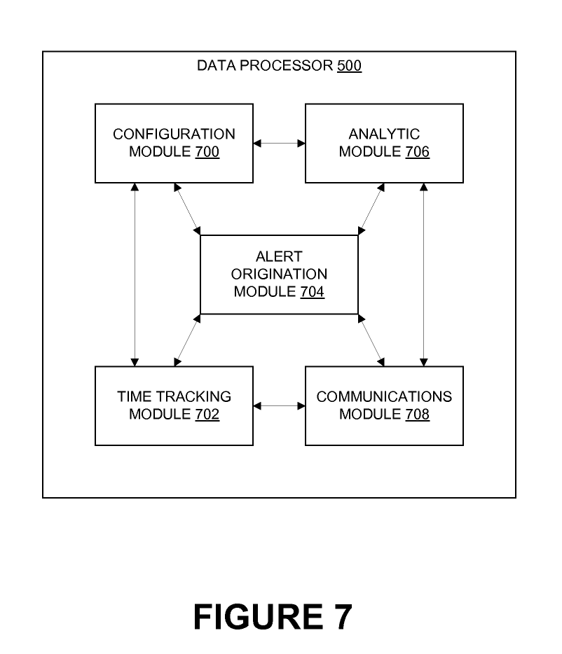

The data processor 500 may process information received from the range measurement device 106, administrative server 110, and/or GPS unit 600 and may execute an instruction generated through a set of modules, as illustrated in FIG. 7. In particular, FIG. 7 depicts a configuration module 700 which may compute a safety distance 108 based on a value data 200 of the first vehicle 100 as determined through the administrative server 110 and/or GPS unit 600, according to one embodiment. FIG. 7 also illustrates a time tracking module 702 which may calculate an amount of time 400 that the distance 104 between the second vehicle 102 and the first vehicle 100 is less than a safety distance 108.

The data processor 500 may further comprise an analytic module 706 which may determine whether the distance 104 is less than the safety distance 108 and whether the distance 104 is maintained for an amount of time 400 that is greater than an acceptable time value 402. In addition, an alert origination module 704 of the data processor 500 may generate an alert 112 when instructed by the analytic module 706. In other words, the alert origination module 704 may generate the alert 112 when the analytic module 706 determines that the distance 104 between the second vehicle 102 and the first vehicle 100 is less than the safety distance 108 and that the distance 104 is maintained for an amount of time 400 that is greater than an acceptable time value 402. FIG. 7 also illustrates a communications module 708 of the data processor 500, which may send the alert 112 to the administrative server 110 through a network 114.

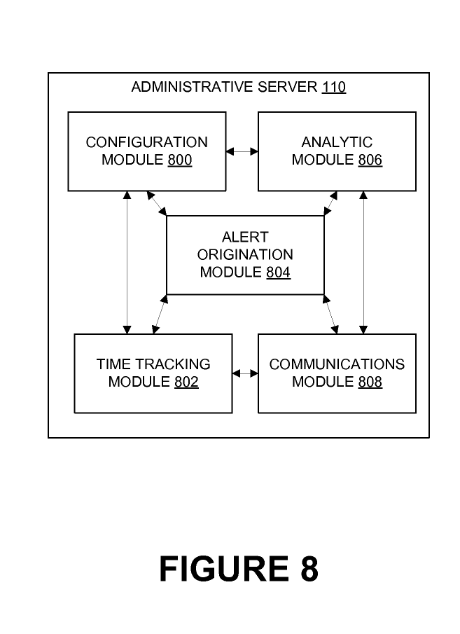

In one embodiment, a system of the first vehicle 100 may comprise a range measurement device 106, GPS unit 600, and data processor 500 which further comprises a configuration module 700, time tracking module 702, analytic module 706, alert origination module 704, and/or communications module 708. In another embodiment, a system of the first vehicle 100 may comprise a range measurement device 106 and/or a GPS unit 600 that are communicatively coupled to an administrative server 110. The administrative server 110 may comprise a configuration module 800, time tracking module 802, analytic module 806, alert origination module 804, and/or communications module 808, as shown in FIG. 8, according to one embodiment.

The modules of the administrative server 110 may perform functions similar to the modules of the data processor 500, with or without slight modifications, according to one embodiment. For example, the communications module 808 of the administrative server may serve to receive communications from the range measurement device 106 and/or the GPS unit 600, whereas the communications module 708 of the data processor 500 may send an alert 112 to the administrative server 110.

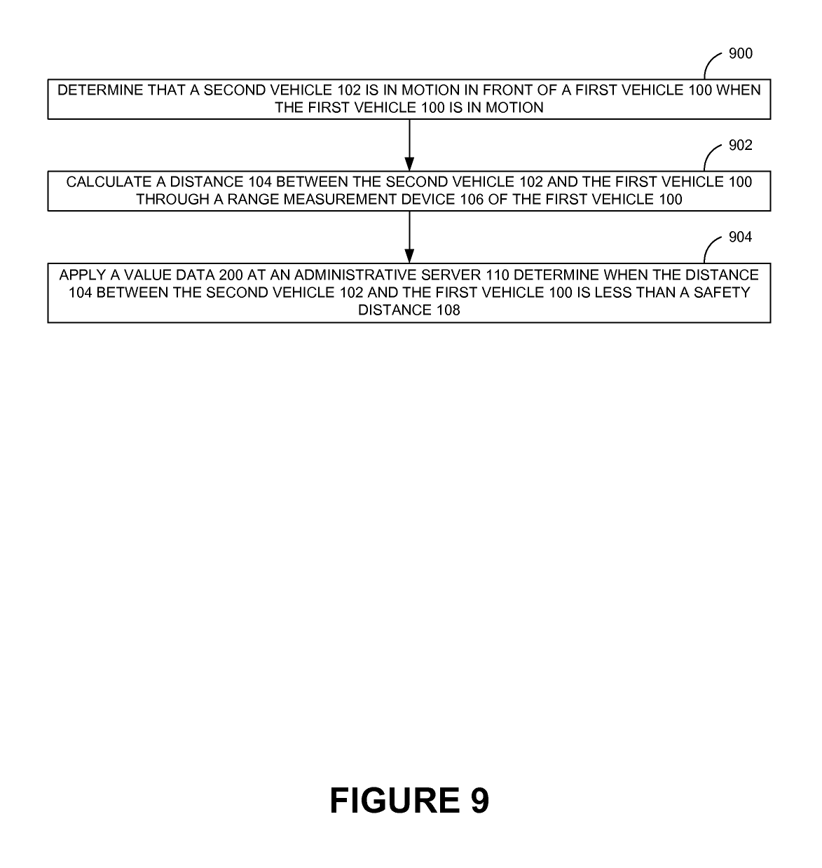

FIG. 9 is a process flow diagram of determining whether the distance 104 between the first vehicle 100 and the second vehicle 102 is less than a safety distance 108, according to one embodiment. In operation 900, a second vehicle 102 in front of the first vehicle 100 is determined to be in motion when the first vehicle 100 is in motion. In operation 902, a distance 104 between the first vehicle 100 and the second vehicle 102 is calculated through a range measurement device 106 of the first vehicle 100. In operation 904, a value data 200 is applied at an administrative server 110 to calculate a safety distance 108 and to determine when the distance 104 is less than a safety distance 108.

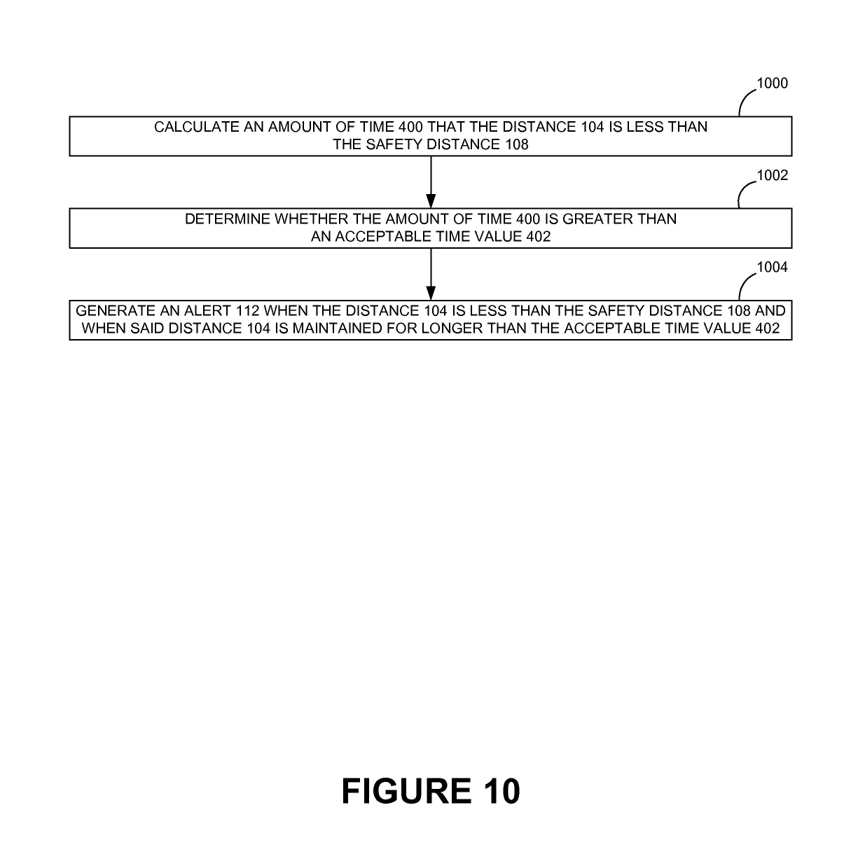

FIG. 10 is a process flow diagram, continued from FIG. 9, of generating an alert 112 when the distance 104 is less than a safety distance 108 and when said distance 104 is maintained for an amount of time 400 that is greater than an acceptable time value 402, according to one embodiment. In operation 1000, an amount of time 400 that the distance 104 between the second vehicle 102 and the first vehicle 100 is less than the safety distance 108 is calculated. In operation 1002, it is determined whether the amount of time 400 is greater than an acceptable time value 402. In operation 1004, an alert 112 is generated when the distance 104 is less than the safety distance 108 and when said distance 104 is maintained for longer than the acceptable time value 402.

An example will now be described in which the various embodiments will be explained in a hypothetical scenario. A company named ‘XYZ Fleet Management’ may wish to monitor fleet vehicles under its surveillance as a preventative measure against vehicle collisions and/or to ensure that the drivers of the fleet vehicles are driving in accordance with a company driving policy. Since vehicle collisions frequently occur when a vehicle fails to maintain a safe following distance behind a vehicle directly in front, the company may wish to ensure that its vehicles are maintaining safe following distances. Maintaining a safe following distance can minimize vehicle accidents and any costs associated therewith. Moreover, the company may need to ascertain if a vehicle is maintaining a safe following distance to ensure driver and public safety and to make key administrative decisions.

However, there are obstacles that may prevent the company from supervising this particular action of a vehicle under its management. The company may encounter difficulties in retrieving such information instantaneously. For example, a remote administrator of the company may be unable to obtain, at will, information pertaining to the following distance maintained by a vehicle and subsequently implement an immediate action in response.

More particularly, the safe following distance to be maintained by a particular vehicle may differ from vehicle to vehicle based on factors such as the vehicle's speed, location (e.g. on a flat roadway, uphill road, curved road etc.), weight, and/or length. Accordingly, a safe following distance may need to be adjusted in light of these variables. Furthermore, an administrator of a company may be unable to determine a safe following distance for every vehicle since it would require knowing constantly changing information about each vehicle. In addition, if the company supervises a large quantity of vehicles (e.g. a fleet of trucks), it may be difficult for the company to monitor each vehicle and determine whether the driver of the vehicle is abiding by a company driving policy (e.g. maintaining a safe following distance).

To overcome these obstacles, XYZ Fleet Management may wish to utilize a system of devices on vehicles under its surveillance such that information obtained by the devices is specific to each vehicle and may be instantaneously communicated to an administrator of the company. In addition, the company may wish to be alerted when the information matches a criteria specified by the company.

For instance, XYZ Fleet Management may wish to obtain information regarding vehicle A, a vehicle under its supervision. XYZ Fleet Management may install a GPS unit, range measurement device, and/or data processor in vehicle A. The three devices may be communicatively coupled so as to allow the transmission of data from one device to another. Furthermore, the data processor may wirelessly communicate with an administrative server that is managed by XYZ Fleet Management. Through the administrative server, XYZ Fleet Management may have access to information regarding the speed of vehicle A, the distance between vehicle A and a vehicle immediately in front thereof, a safety distance that should be maintained by vehicle A, and/or an amount of time that vehicle A maintains the distance between itself and the vehicle immediately in front. Through the administrative server, XYZ Fleet Management may also be notified, via an alert notification, if vehicle A is maintaining an appropriate safety distance, which may ultimately be determined according to a set of rules and/or a company driving policy.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer device). Accordingly, the specification and drawings are to be regarded in an illustrative in rather than a restrictive sense.

What is claimed is:

1. A method of a first vehicle comprising:
determining that a second vehicle is in motion in front of the first vehicle when the first vehicle is in motion;
calculating a distance between the second vehicle and the first vehicle when the first vehicle and the second vehicle are in motion through a range measurement device of the first vehicle; and
generating an alert at an administrative server when the distance between the second vehicle and the first vehicle is less than a safety distance.

2. The method of claim 1 further comprising:
applying a value data at the administrative server to determine when the distance between the second vehicle and the first vehicle is less than the safety distance.

3. The method of claim 2 wherein the value data comprises at least one of a type of the first vehicle, a weight of the first vehicle, a speed of the first vehicle, a size of the first vehicle, and a length of the first vehicle.

4. The method of claim 2 wherein the safety distance is determined based on the value data.

5. The method of claim 1 further comprising: calculating the distance through an algorithm applied by the range measurement device that measures a physical separation between a posterior area of the second vehicle and an anterior area of the first vehicle.

6. The method of claim 1 further comprising:
determining that the second vehicle and the first vehicle are traveling in substantially a same direction.

7. The method of claim 1 further comprising:
calculating an amount of time that the distance between the second vehicle and the first vehicle is less than the safety distance;
determining whether the amount of time is greater than an acceptable time value; and
communicating the distance and the amount of time to the administrative server communicatively coupled with the first vehicle.

8. A method of a first vehicle comprising:
calculating a distance between a second vehicle and the first vehicle when the first vehicle and the second vehicle are in motion through a range measurement device of the first vehicle;
applying a value data to determine when the distance between the second vehicle and the first vehicle is less than a safety distance;
calculating an amount of time that the distance between the second vehicle and the first vehicle is less than the safety distance;
determining whether the amount of time is greater than an acceptable time value;
generating an alert when the distance between the second vehicle and the first vehicle is less than the safety distance and when said distance is maintained for longer than the acceptable time value; and
communicating the alert to an administrative server.

9. The method of claim 8 further comprising:
determining that the second vehicle is in motion in front of the first vehicle when the first vehicle is in motion.

10. The method of claim 8 further comprising:
calculating the distance through an algorithm applied by the range measurement device that measures a physical separation between a posterior area of the second vehicle and an anterior area of the first vehicle.

11. The method of claim 8 wherein the value data comprises at least one of a type of the first vehicle, a weight of the first vehicle, a speed of the first vehicle, a size of the first vehicle, and a length of the first vehicle.

12. The method of claim 8 wherein the safety distance is calculated based on the value data.

13. The method of claim 8 further comprising:
determining that the second vehicle and the first vehicle are traveling in substantially a same direction when generating the alert.

14. A first vehicle comprising:
a Global Positioning System unit that communicates with a space based navigation system to determine a present location of the first vehicle and a speed of the first vehicle;
a range measurement device that detects a distance between the first vehicle and a second vehicle in front of the first vehicle; and
a data processor that processes information generated by the Global Positioning System unit and the range measurement device and which executes an instruction generated through a communication between an administrative server and the first vehicle.

15. The first vehicle of claim 14 further comprising:
a configuration module to compute a safety distance based on a value data of the first vehicle as determined through the administrative server.

16. The first vehicle of claim 15 wherein the value data comprises at least one of a type of the first vehicle, a weight of the first vehicle, the speed of the first vehicle, a size of the first vehicle, and a length of the first vehicle.

17. The first vehicle of claim 14 further comprising:
a time tracking module to calculate an amount of time that the distance between the second vehicle and the first vehicle is less than a safety distance.

18. The first vehicle of claim 14 further comprising:
an analytic module to determine:
when the distance is less than a safety distance, and
when said distance is maintained for an amount of time that is greater than an acceptable time value.

19. The first vehicle of claim 14 further comprising:
an alert origination module to generate an alert communication when the distance is less than a safety distance and when said distance is maintained for an amount of time that is greater than an acceptable time value.

20. The first vehicle of claim 14 further comprising:
a communications module to send an alert communication to the administrative server through a network.
